(19) United States
(12) Patent Application Publication
(10) Pub. No.: US 2023/0309537 A1
(43) Pub. Date: Oct. 5, 2023

(54) Apparatus and Method for Applying Insecticide in Combination with Adhesive

(71) Applicant: James Howes, Newport, RI (US)

(72) Inventor: James Howes, Newport, RI (US)

(21) Appl. No.: 17/687,078

(22) Filed: Mar. 4, 2022

(51) Int. Cl. A01M 1/14; A01M 1/20; A01M 3/04

(52) U.S. Cl. CPC A01M 1/14; A01M 1/20; A01M 3/04; A01M 2200/011

(57) ABSTRACT

An apparatus and method for capturing and killing ticks. In one embodiment a surface on a roller is coated with an adhesive combined with a compound of cedar oil, citronella oil and rosemary oil. When the roller surface of the apparatus is pressed against a tick, the tick adheres to the surface by the pressure-sensitive adhesive and is subsequently killed by the oil compound.

### TECHNICAL FIELD

The invention relates to devices that prevent crawling insects such as ticks from attaching to a person, and to compositions of matter containing insecticide and adhesives for the purpose of capturing and killing parasitic insects; and to methods of the above.

### BACKGROUND

Hand-held rollers are commonly used in applications from applying adhesive tape, to dispensing cling-wrap for packaging, to removing lint from clothing. Hand-held rollers commonly have a handle or grip mechanism attached to an axle. With these types of dispensers, a roll of material is placed on a roller on an axel, and as the roller rotates on its axle, the material on the roller is dispensed onto another surface. One skilled in the art is familiar with dispensers that have adhesive on the inside, outside or both sides of the material dispensed.

Lyme disease, also referred to as Lyme Borreliosis, is an infectious disease caused by the Borrelia bacterium which is commonly spread by ticks. Early symptoms include a rash surrounding the tick bite and may be followed by headaches, fever and/or fatigue. If untreated, symptoms may include facial paralysis, joint pain, heart palpitations, or long-term, disabling symptoms.

Ticks are parasitic arachnids that often carry Lyme disease. Lyme disease usually takes up to 36 hours to transfer from a tick to a mammal. It is preferable to remove ticks from one’s skin and clothing before they have had time to attach to the skin and potentially transfer Lyme disease.

Cedar oil is an essential oil derived from conifers, particularly those of the cypress botanical family. Although specific characteristics of cedar oil derived from various species may vary, all forms of cedar oil provide antibacterial and pesticide properties.

Salvia Rosmarinus is commonly known as the rosemary plant and is a woody perennial herb having evergreen, needle-type leaves. Essential oil derived from the rosemary plant shows some insecticidal properties.

Citronella oil and lemongrass oil are derived from the leaves and stems of various species of Cymbopogon or lemongrass, respectively. Citronella oil is commonly used as an insect repellent and pesticide.

Natural adhesives are derived from tree resins or plant saps. Polymeric adhesives are commonly made from acrylate-based polymers. Pressure-sensitive Adhesives (PSA) are acrylate-based polymers, commonly used for adhesive tapes, labels and other sticky surfaces. Pressure-sensitive adhesives, as the name applies, are activated by pressure to adhere to surfaces that are relatively dry and free of oil. A pressure-sensitive adhesive combined with an appropriate insecticide may remove ticks from a surface and kill the ticks.

### SUMMARY

An apparatus and method for capturing and killing ticks has in one embodiment a roller with a surface coated with an adhesive combined with a compound of cedar oil, citronella oil and rosemary oil. When the embodiment’s roller surface is pressed against a tick, a pressure-sensitive adhesive on the embodiment’s surface adheres to the tick. The embodiment’s cedar-citronella-rosemary oil compound subsequently kills the tick. In some embodiments the coated surface is rolled with the adhesive side facing out. The roller resides on an axle that is affixed to a handle.

One skilled in the art understands that various adhesives may be used to capture a tick. In some embodiments natural adhesives may be employed while other embodiments include polymeric adhesives. In some embodiments, the ratio of adhesive to insecticide composition is between 0.85 and 0.97 and preferably between 0.92 and 0.96. In one example embodiment a flexible surface is coated with a compound comprising 96% adhesive by volume and 4% insecticide by volume.

An example insecticide consists essentially of one part cedar oil, one part citronella oil and one part rosemary oil. In other embodiments an example insecticide consists essentially of up to 2% cedar oil, up to 9% rosemary oil and up to 2% citronella oil. In another embodiment an example insecticide consists essentially of up to 1% cedar oil; up to 8% rosemary oil and up to 1% citronella oil.

The presented drawings are intended to illustrate an embodiment rather than limit the disclosure.

### BRIEF DESCRIPTION OF THE DRAWINGS

FIG. 1 is a perspective view of an example embodiment.

FIG. 2 is another perspective view of an example embodiment.

### DESCRIPTION

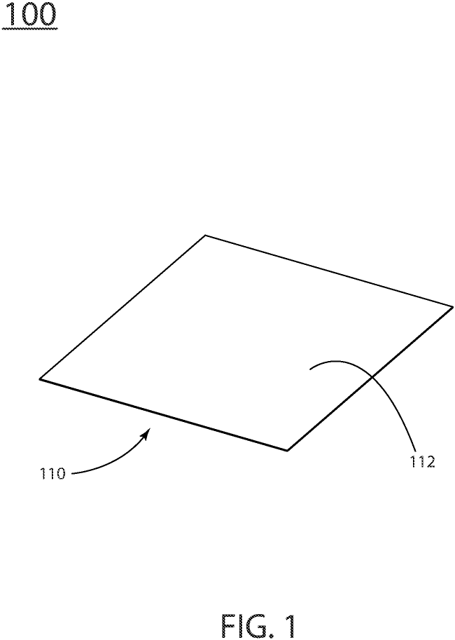

FIG. 1 shows an example embodiment 100. A surface tape 110 is coated with a composition 112 consisting essentially of cedar oil, rosemary oil and citronella oil according to proportions disclosed.

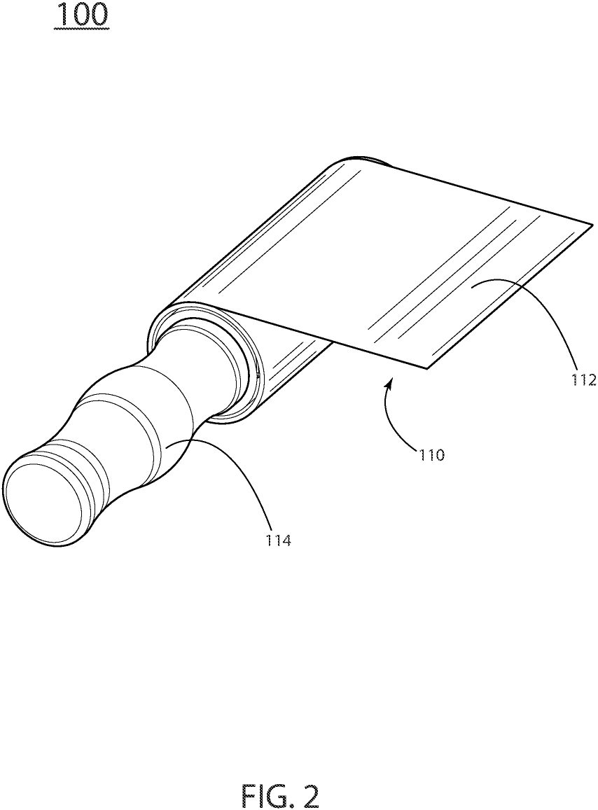

FIG. 2 shows an example embodiment 100 as a tape rolled on a handle 114. In assembly, the surface tape 110, which is coated with the aforementioned compound 112, is rolled on the handle 114. In use, the tape may be rolled over one’s person, over skin or clothing or on one’s pets or other animals. Ticks that come in contact with the compound 112 of the adhesive on the surface 110 will become stuck in the adhesive and will eventually be killed by the insecticide.

One skilled in the art understands that various handles may be used with various-sized rolls, and that the apparatus may be contained in an integrated or a separate container.

These embodiments should not be construed as limiting.

1. A method and apparatus for capturing and killing ticks, the apparatus comprising:
a surface configured to support a compound of insecticide and a polymeric adhesive; wherein
the application of said surface to a tick causes the tick to be trapped in said adhesive while it is killed by said insecticide.

2. The apparatus of claim 1 further comprising:
said surface configured as a roll; and
said roll having a hollow center; and
said roll with hollow center rotationally engaged with an axle; and
said axle fixedly engaged with a handle; wherein
the roll of said surface configured to support a compound of insecticide and polymeric adhesive is rolled on a user’s skin and clothing to adhere ticks to said adhesive and to kill said ticks with said insecticide.

3. The apparatus of claim 1 further comprising:
said surface configured as a roll of perforated sheets;
each sheet being approximately the length of the average roll diameter; wherein
removal of a used sheet exposes an unused sheet.

4. The apparatus of claim 1, the polymeric adhesive selected from the group consisting of: acrylate-based polymers.

5. The apparatus of claim 1, the polymeric adhesive comprising:
10% by volume oil; and
90% by volume adhesive.

6. The apparatus of claim 1, the insecticide selected from the group consisting of:
cedar oil, rosemary oil, citronella oil.

7. The apparatus of claim 1, the insecticide comprised of:
up to 2% by volume cedar oil; and
up to 9% by volume, rosemary oil; and
up to 2% by volume citronella oil.

8. The apparatus of claim 1, the insecticide comprised of:
up to 1% by volume cedar oil; and
up to 8% by volume, rosemary oil; and
up to 1% by volume citronella oil. (preferred/narrower range).

9. A method for capturing and killing ticks, employing the apparatus of claim 1, the method comprising:
providing said surface configured to support a compound of insecticide and a polymeric adhesive; and
configuring said surface to a roll; and
rolling said roll over a user’s skin and clothing; wherein
ticks residing on the user’s skin and clothing become trapped in said adhesive and killed by said insecticide.

10. The method of claim 9 further comprising:
axially engaging said roll with an axle; and
fixedly engaging said axle with a handle; and
holding said handle while rolling said roll over a user’s skin and clothing.

11. An apparatus for capturing and killing ticks comprising:
a surface configured to support a compound of insecticide and a polymeric adhesive; and
said surface configured as a roll; and
said insecticide comprised of:
up to 1% by volume cedar oil; and
up to 8% by volume, rosemary oil; and
up to 1% by volume citronella oil; and
said polymeric adhesive comprising:
10% by volume oil; and
90% by volume adhesive;
wherein
the application of said surface by rolling it over a tick causes the tick to be trapped in said adhesive while it is killed by said insecticide.

12. A method for capturing and killing ticks, employing the apparatus of claim 11, the method comprising:
providing said surface configured to support a compound of insecticide and a polymeric adhesive; and
configuring said surface to a roll; and
rolling said roll over a user’s skin and clothing; wherein
ticks residing on the user’s skin and clothing become trapped in said adhesive and killed by said insecticide.

13. The method of claim 12 further comprising:
axially engaging said roll with an axle; and
fixedly engaging said axle with a handle; and
holding said handle while rolling said roll over a user’s skin and clothing.
